(19) United States
(12) Patent Application Publication
(10) Pub. No.: US 2019/0026634 A1
(43) Pub. Date: Jan. 24, 2019

(54) INFERRING ROLES IN A WORKFLOW WITH MACHINE LEARNING MODELS

(71) Applicant: CA, Inc., Islandia, NY (US)

(72) Inventors: Andrew Homeyer, Islandia, NY (US); Kelli Hackethal, Islandia, NY (US); Megan Espeland, Islandia, NY (US); Mary Davis, Islandia, NY (US); Jacob Burton, Islandia, NY (US)

(21) Appl. No.: 15/655,099

(22) Filed: Jul. 20, 2017

(51) Int. Cl. G06N 5/04; G06N 99/00; G06Q 10/10

(52) U.S. Cl. CPC G06N 5/04; G06Q 10/103; G06N 99/005

(57) ABSTRACT

Provided is a process, including: obtaining a workflow execution log; training a first supervised machine learning model to infer roles of users in the workflows based on the workflow execution log; obtaining a given instance of a given workflow; inferring, with the first supervised machine learning model, at least one role of at least one user in the given instance of the given workflow; and causing at least part of the given instance of the given workflow to be presented to the at least one user in a user interface.

### BACKGROUND

### 1. Field

The present disclosure relates generally to project management software applications and, more specifically, to inferring roles in a workflow with machine learning models.

### 2. Description of the Related Art

Many software-development projects are relatively complex. Often dozens or hundreds of developers or operations engineers contribute to writing and modifying computer code, in many cases, across multiple branching and merging versions of the code, which can run into ten-of-thousands of lines of code in many projects. In many cases, teams use project management applications to track and coordinate their workflows in development tasks, such as a software-development workflow tracking system.

Often, configuring and using project management applications is burdensome. Part of that burden arises from mapping team members to roles in a workflow, defining those roles, designating priorities of tasks in workflows, estimating when tasks will be completed, and sequencing tasks. Often a given user may participate in dozens of workflows on several projects, and each project may have multiple team members, in many cases numbering in the dozens or hundreds. As a result these burdensome tasks can multiply to the point that users rely on partially configured projects or fail to use features that would otherwise make their work more productive.

Existing computer systems for project management are not well suited to address this problem, as many such systems leave it to the developer to manually assign tasks, priorities, roles, and sequences of tasks. Computer systems for automatically assigning these parameters are deficient in that they are often exclusively based on hand-coded rules that can be expensive to compose and are brittle when adapting to changes in how the project management system is used.

### SUMMARY

The following is a non-exhaustive listing of some aspects of the present techniques. These and other aspects are described in the following disclosure.

Some aspects include a process including: obtaining, with one or more processors, a workflow execution log, wherein: the workflow execution log comprises a plurality of workflow instance records, each workflow instance record documents a respective instance of a respective workflow being executed, the workflow instance records describe a plurality of different workflows, each workflow includes a plurality of tasks, each workflow has a plurality of different workflow instance records in the workflow execution log, and each workflow instance record indicates which user performed each of the plurality of tasks in the respective workflow, training, with one or more processors, a first supervised machine learning model to infer roles of users in the workflows based on the workflow execution log, wherein training the first model to infer roles of users in the workflows comprises: obtaining initial parameters of the first model to infer roles of users in the workflows; repeatedly, until a termination condition occurs, determining an aggregate amount of error or fitness between inferences of the first model and a plurality of the workflow instance records, and adjusting the parameters of the first model in a direction that reduces the aggregate amount of error or increases the aggregate amount of fitness; and storing the adjusted parameters in memory; after training the first supervised machine learning model, obtaining, with one or more processors, a given instance of a given workflow; inferring, with one or more processors implementing the first supervised machine learning model, at least one role of at least one user in the given instance of the given workflow; and causing, with one or more processors, based on inferring at least one role of at least one user, at least part of the given instance of the given workflow to be presented to at least one user in a user interface.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a block diagram showing an example of a project management computer system and related computing environment in accordance with some embodiments of the present techniques;

FIG. 2 shows an example of a process to infer roles of users in workflows in accordance with some embodiments of the present techniques;

FIG. 3 shows an example of a process to train a model used in the process of FIG. 2 in accordance with some embodiments;

FIG. 4 shows an example of a process to estimate timing of various tasks in accordance with some embodiments of the present techniques; and

FIG. 5 shows an example of a computer system by which the above techniques may be implemented in some embodiments.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the fields of computer science, data science, and software-development tooling. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Some embodiments infer roles or infer mappings of people (e.g., user identifiers) to those roles in various workflows based on logged interactions with a project management computer system. In some cases, additional context for software issues is inferred, e.g., based on role or person. For instance, some issues may be designated as having an elevated priority based on historical data indicating issues assigned to a given user or given role being more likely to have a higher priority.

Some embodiments implement the inferences with a machine learning model trained on interaction logs from previous usage of a workflow tracking system. In some cases, the interactions are associated with time stamps, and older interactions are discarded or down-weighted (e.g., with a half-life) to allow the model to update to reflect changes in roles.

A variety of different models may be used. Some embodiments may implement a hidden Markov model (e.g., with role as a hidden state) or recurrent neural network (e.g., a long short term memory (LSTM) model) in which a sequence of users in a workflow is learned. In some cases, users having similar transition probabilities at a given task in a sequence of tasks in a workflow may be grouped into a role.

Priorities may be inferred with various techniques, including a neural net classifier that classifies priority based on role, user, or various attributes of the issue. Other models contemplated include a classification tree trained on historical data.

In some cases, the user interface (UI) of a dashboard of the project management computer system may be augmented with data indicative of the inferences. For instance, a position of a task in a workflow may be inferred based on previous and current inferred roles of users who have processed the task. In some cases, a visual weight of a task in the UI may be adjusted based on an inferred priority. In some cases, an inventory of tasks may be presented by selecting tasks to present to a user based on an inferred role of the user and an inferred place of the tasks in a workflow.

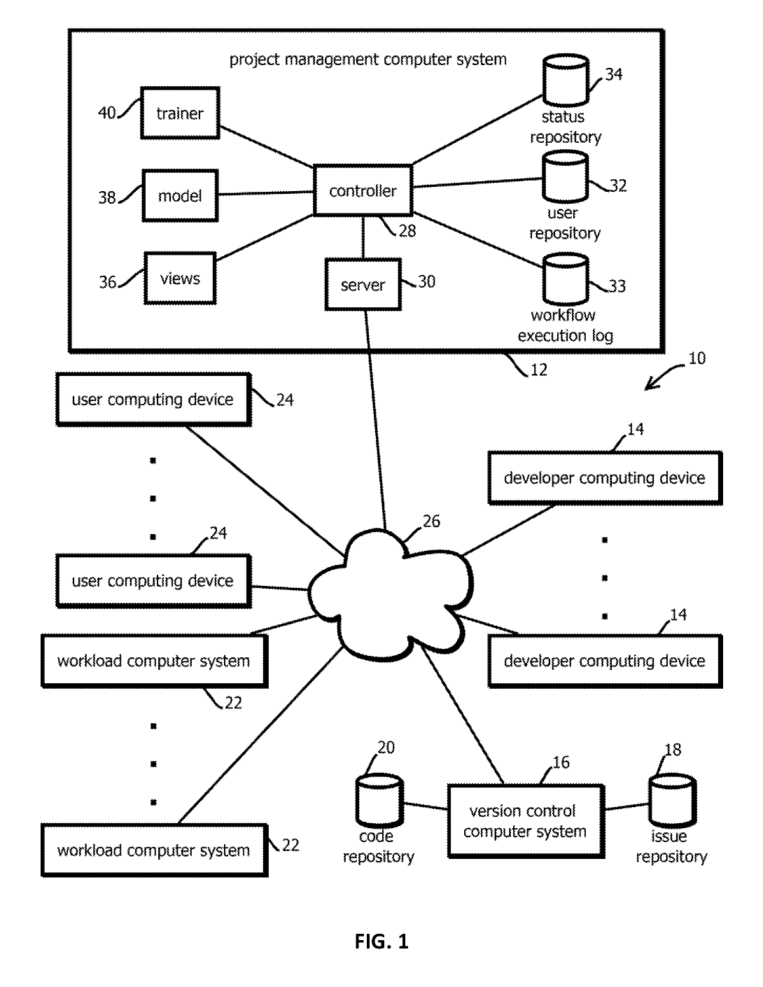

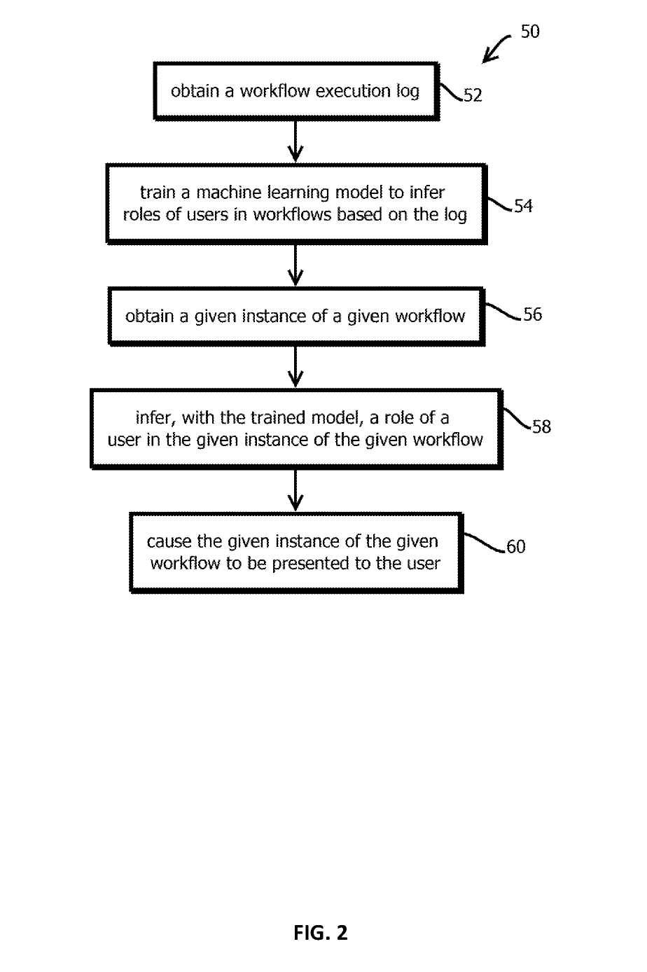

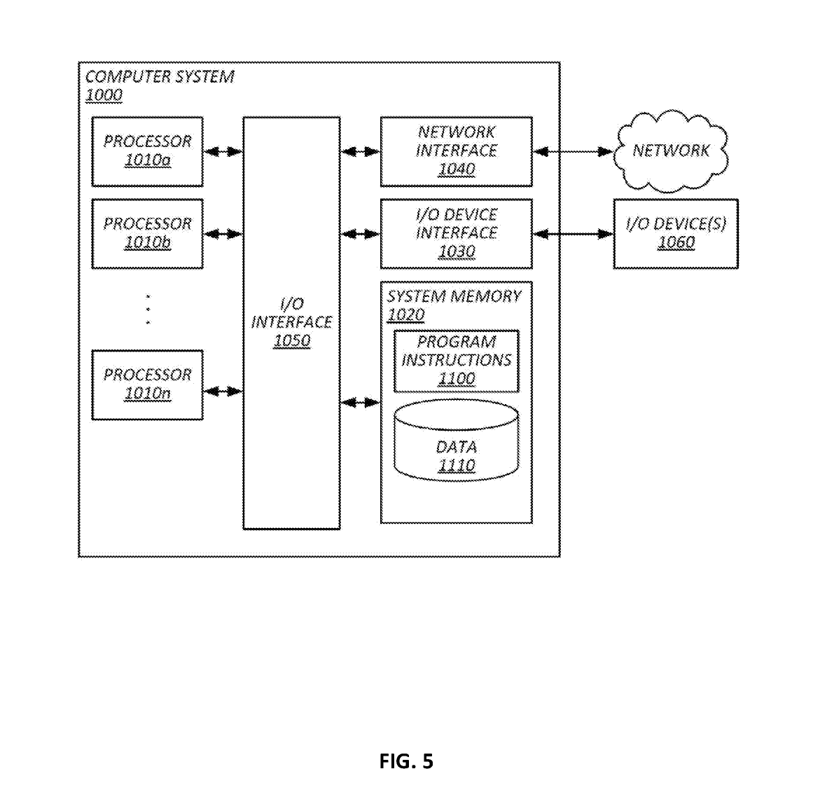

In some embodiments, these and other techniques may be implemented in a computing environment 10 (including each of the illustrated components) shown in FIG. 1 having the illustrated project management computer system 12. The project management computer system 12 may be configured to track the status of software-related projects (and other projects) through workflows by implementing techniques like those described above. In some embodiments, this project management computer system 12 may execute processes described below with reference to FIGS. 2-4 and may be implemented with one or more of the computer systems shown in FIG. 5.

In some embodiments, the computing environment 10 includes a plurality of developer computing devices 14, a version control computer system 16 having an issue repository 18, a code repository 20, a plurality of workload computer systems 22, and a plurality of computing devices 24. In some cases, the computer systems may be a single computing device or a plurality of computing devices, for instance, executing in a public or private cloud. In some embodiments, these computing devices may communicate with one another through various networks, such as the Internet 26 and various local area networks.

In some embodiments, the developer computing devices 14 may be operated by developers that write and manage software applications. In some cases, source code for the software applications may be stored in the version control computer system 16, for instance, in the code repository 20. In some cases, this code may be executed on the workload computer systems 22, and in some cases, user computing devices 24 may access these applications, for instance, with a web browser or native application via the Internet 26 by communicating with the workload computer systems 22. In some embodiments, the computing environment 10 and the project management computer system 12 are multi-tenant environments in which a plurality of different software applications operated by a plurality of different entities are executing to serve a plurality of different groups of user computing devices 24. In some cases, groups of developer computing devices 14 may be associated with these entity accounts, for instance, in the version control computer system 16 and the project management computer system 12, such that developers associated with those accounts may selectively access code and projects in these respective systems.

In some embodiments, the version control computer system 16 having the repositories 18 and 20 is a Git version control system, such as GitHub™, Bitbucket™, or GitLab™. Or embodiments are consistent with other types of version control systems, including Concurrent Versions System™, or Subversion™. In some cases, the version control computer system 16 includes a plurality of different version histories of a plurality of different software applications in the code repository 20. In some embodiments, the version control computer system 16 may organize those records in an acyclic directed graph structure, for instance, with branches indicating offshoots in which versions are subject to testing. In some cases, these offshoots may be merged back into a mainline version. In some embodiments, some versions may be designated as production versions or development versions. In some embodiments, the source code in each version may include a plurality of subroutines, such as methods or functions that call one another, as well as references to various dependencies, like libraries or frameworks that are called by, or that call, these subroutines. In some cases, a given version of software may be characterized by a call graph indicating which subroutines call which other subroutines or libraries or frameworks. In some cases, the source code may include various reserved terms in a programming language as well as tokens in a namespace managed by the developer or a developer of libraries or frameworks. These reserve terms may include variable names and names of subroutines in the source code, libraries, or frameworks that are called. Some embodiments may leverage the resulting namespaces to match roles to code changes and related tasks.

In some embodiments, the version control computer system 16 may further include an issue repository 18. In some cases, developers, through developer computing devices 14 or users through user computing devices 24 may submit software-issue reports indicating problems with software or requested features for software executing on the workload computer systems 22. In some embodiments, each resulting software-issue report may include a description of the issue, for instance in prose, entered by a user or developer describing the problem. In some cases, the description may be in a human-readable, non-structured format and may range in length from three words up to several hundred or several thousand words or more.

In some cases, the software-issue reports may also include structured data, for instance, based on check boxes, radio buttons, or drop-down menu selections by a user or developer submitting a software-issue report via a user interface that the version control system 16 or project management computer system 12 causes to be presented on their respective computing device. In some cases, these values may indicate severity of an issue, whether the issue is a request for a new feature or a request to fix a problem, values indicating a type of the problem, like whether it relates to security, slow responses, or problems arising in a particular computing environment. In some cases, the request may also include a description of the computing device upon which the problem is experienced, like a manufacturer, operating system, operating system version, firmware versions, driver versions, or a geolocation of the computing device. In some cases, the report further includes timestamp indicating when the software-issue report was submitted and an identifier of a software application to which the report pertains, such as one of the software applications associated with a version history in the code repository 20 and an application executing on some of the workload computer systems 22. In some cases, each software application may include an application identifier used by the version control system to identify that software application in the code repository 20 and the issue repository 18. In some cases, one or more of these software issue reports may be addressed by a workflow instance created to address the software issue report, in some cases, based on a template workflow specifying, for instance, tasks like triage, code change, manager review, unit tests, quality assurance, limited release, and full release.

In some embodiments, the version control system 16 may also maintain accounts associated with different entities authorized to access source code associated with each of a plurality of different applications and roles and permissions of developers associated with respective credentials by which developers associated with those entities make changes to the source code. In some embodiments, developers may submit changes to source code in the code repository 20, for instance, with a “commit” in some embodiments, each commit may be associated with a timestamp, a unique identifier of the commit, an application, and a branch and location in a branch in a version history of the application in the code repository 20. In some embodiments, the commits may be encoded as differences between a current version in the respective branch and the committed version, for instance, identifying code that is deleted and identifying code that is added as well as including the deletions and additions. In some cases, this may be characterized as a “diff” relative to the existing code in the most current version of a branch to which the changes submitted.

In some embodiments, the submission may be made by the developer computing devices 14 directly to the version control computer system 16, and the version control system 16 may emit an event indicative of the submission to the project management computer system 12, which may execute an event handler configured to initiate the described responsive actions. Or in some cases, the submissions may be sent by the developer computing devices 12 to the project management system 12, which may then send the changes to the version control computer system 16. Or the version control computer system 16 or the repositories 18 or 20 may be integrated with the project management computer system 12.

In some embodiments, the project management computer system 12 is configured to track the status of a plurality of different projects for a plurality of different tenants. In some cases, the projects relate to development and maintenance of the software applications described above. In some cases, the project management computer system 12 is further configured to manage and track workflows by which these projects are implemented and maintained, for instance, routing tasks from one user to another user, such as a developer users or operations engineer users, as a given project is advanced through a series of tasks in the project. Further, in some cases, the project management computer system 12 is configured to form and cause the presentation of various dashboards and displays indicative of the status of the projects and task queues of respective users having tasks assigned to them, their group, or to someone in their role. Corresponding records may be created, updated, and accessed by the project management computer system 12 in memory to effectuate this functionality.

To these ends or others, in some embodiments, the project management computer system 12 includes a controller 28, a server 30, a user repository 32, a workflow execution log, a status repository 34, a view generator 36, an inference model 38, and a trainer 40. In some embodiments, the controller 28 may execute the processes described below with reference to FIGS. 2 through 4 and coordinate the operation of the components of the project management computer system 12.

In some embodiments, the server 30 may monitor a network socket, such as a port and Internet protocol address of the project management computer system 12, and mediate exchanges between the controller 28 and the network 26. In some embodiments, the server 30 is a nonblocking server configured to service a relatively large number of concurrent sessions with developer computing devices 14, such as more than 100 or more than 1000 concurrent sessions. In some embodiments, multiple instances of the server 30 may be disposed behind a reverse proxy configured to operate as a load balancer, for instance, by allocating workload to different instances of the server 30 according to a hash value of a session identifier.

In some embodiments, the user repository 32 includes records identifying users of the project management computer system 12 under various tenant accounts. In some cases, this may include a tenant record listing a plurality of user records and roles and permissions of those users. In some embodiments, each user record may indicate credentials of the user, a unique identifier of the user, a role of the user, and configuration preferences of the user. In some cases, the number of users may be more than 100,000 users for more than 10,000 tenants.

In some embodiments, the user repository 32 may include a plurality of workflows associated with user accounts, such as workflows by which a given type of software issue report is addressed or a feature is added or a new version of code is released. In some cases, the user repository 32 may include a plurality of tenant records and each tenant record may include a plurality of teams, each team listing users on a respective team and in some cases roles of users on the team or role names (e.g., job titles) of users on the team. Further, in some cases, each of these teams or the tenants may be associated with corresponding workflow definitions. In some cases, the workflow definitions may include a sequence of tasks to be performed in the course of the workflow. In some embodiments, the project management system 12 may be operative to present tasks in those workflows assigned to users in user interfaces via the server 30 on the user computing devices or developer computing devices 14 or 24.

The workflow execution log 33 may include a plurality of workflow instance records. In some embodiments, each workflow instance record documents a previous instance in which a given workflow was executed. In some embodiments, each workflow instance record may include an identifier of the workflow, an identifier of the instance of that workflow, an identifier of a tenant of the project management system that has a project in which the workflow is executed, and a list of task records of tasks performed in the course of the workflow. In some embodiments, each task record may include an identifier of a user that performed the task, an identifier of the task, a description of the task, a time at which the task was started, and a time at which the task was completed. In some embodiments, the workflow execution log 33 may be a relational database or a noSQL database, for instance, storing workflow instance records in serialized hierarchical documents, like XML or JSON. In some embodiments, the workflow execution log 33 may store a relatively large number of such documents, for instance, more than 1000, and in many commercially relevant use cases, more than 10,000 or more than 100,000 workflow instance records. In some embodiments, the workflow instance records may be gathered over a trailing duration of time, for instance, over more than a previous week, month, year, or longer. In some cases, a given workflow may correspond to a plurality of different workflow instance records in which that given workflow was performed.

In some embodiments, the status repository 34 may include a plurality of project records, each project record corresponding to a project for which status is tracked. In some embodiments, the project records may include a workflow, a current status in the workflow, and tasks associated with various stages of the workflow. In some cases, the tasks may be arranged sequentially or concurrently, indicating whether one task blocks (i.e., must be completed before) a subsequent task. In some cases, the tasks may be associated with respective roles indicating a person or role of people to whom the task is to be assigned (or in some cases, one or both of these attributes may be blank in some records), in some cases referencing records in the user repository 32. In some embodiments, as users progress through tasks, the project management computer system 12 may receive updates from users interacting with user interfaces of the project management computer system presented on remote computing devices of the users. The status repository records may be updated to reflect the reported changes, e.g., that a task is complete, a task is to be reassigned to a different user, a new workflow is initiated, a new project is initiated, or the like.

In some embodiments, the status repository 30 may further include a plurality of workflow instance state records, each workflow instance state record including a workflow that has not yet been completed or otherwise closed. Each workflow instance state record may include a partial workflow instance record like those described above in the workflow execution log 33, for instance documenting task records for tasks that have been completed and including a list of incomplete tasks. In some cases, the workflow instance state records may indicate which tasks are necessarily precursors to other tasks and which tasks can be performed concurrently. In some embodiments, users of the project management system 12, via a user interface on the respective computing devices 14 or 24, may define workflows and enter updates in the status of ongoing workflows in which they participate. A new workflow instance state record may be created upon initiating a new instance of a workflow, and that state record may be transferred to the workflow execution log 33 upon completion or closing of the workflow instance being indicated by a user via a user interface.

In some cases, a sequence of tasks may be generated by controller 28 responsive to submission by a computing device 14 or 24 of a software-issue report stored in the issue repository 18. For example, such a project may include a triage task to evaluate whether the software-issue report is valid or has already been addressed, a diagnostic task, a code-change task by which the change is implemented, a unit test task by which unit tests are run (or written for new code) and results analyzed, a quality assurance task by which the submission is tested, a partial release task by which code implementing the change is released to a test environment or sample of a user base, and a full release task by which the code change is released in a non-test, production version of the corresponding application. In some embodiments, different users (e.g., in virtue of having a role or being in a group) may be assigned different ones of these different tasks, and the status of each software-issue report through such a workflow may be tracked. In some cases, different tenants or applications may have workflow templates associated therewith in memory of the system 12, and a template defining such a workflow, or other different workflows, may be managed by controller 28 based on such templates.

In some cases, issue submissions, such as software-issue reports may be sent by users or developers to the version control computer system 16, which may emit an event to the project management computer system 12 containing a description, such as the full record, of the report, or in some cases, software-issue reports may be submitted to the project management computer system 12, which in some cases, may house the issue repository 18. In some embodiments, each of the version control computer system and code repositories 20 may also be integrated with the project management computer system 12. In some cases, software-issue reports may be obtained via CA Agile Central, available from CA, Inc. of Islandia, N.Y.

In some embodiments, the view generator 36 may be configured to generate various user interfaces by which users view the status of their projects, dashboards, and task queues, as well as create new (or modify) workflows and projects. In some cases, these views may include a queue of tasks for a given user, a queue of tasks for a group of users in a role, a queue of tasks for a project, or the like. In some cases, these views may further include a graphical representation of the status of a given project through a workflow, for instance, indicating which tasks has been performed, which tasks remain to be performed, and which tasks are serving as blocking tasks for other sequential tasks. In some embodiments, these views may be presented on developer computing devices 14. In some embodiments, the project management computer system 12 is configured to cause presentation of these views by sending instructions to the developer computing devices 14 to render the views (e.g., with webpage markup and scripting rendered in a client-side browser). Or in some cases, the project management computer system 12 may be executed by one of the developer computer systems 14, and causing presentation may include instructing the same computing device to present the view. In some embodiments, the views may be encoded as dynamic webpages, for instance, in hypertext markup language and include various scripts responsive to user inputs and configured to send data indicative of those inputs to the project management computer system 12.

As noted above, in many cases, the more detail with which workflows and user roles are specified, the greater effort imposed upon users of the project management system 12, making the system less desirable and useful. To mitigate these issues, some embodiments may include a model module 38 by which various attributes of tasks and workflow instances or workflows are inferred. In some embodiments, one or more models of the model module 38 may be trained by a training module 40, for instance based on records in the workflow execution log 33. Thus, some embodiments may learn, based on previous workflow instance records, additional attributes about tasks or user roles in workflows, without imposing a burden on users to manually define these attributes. Further, some embodiments may make these inferences with various machine learning and statistical models that are relatively robust to changes in use cases of the project management system computer system 12. Thus, some embodiments may mitigate problems arising from relatively brittle, hand-coded rules used in some traditional automation techniques (which is not to suggest that embodiments are not also consistent with use of these rules or that other features are not also amenable to variation). In other words, some embodiments may generalize from the records in the workflow instance records, attributes of tasks, workflows, and users' (e.g., developers or operations engineers using the system 12) roles in those workflow instances.

Examples of models and training of the models are described below with reference to FIGS. 2 through 4. In some embodiments, the models are machine learning models (e.g., supervised or unsupervised), and in some cases, the models are statistical models. In some embodiments, the models may account for sequential aspects of workflows, for instance, with hidden Markov models or various forms of recurrent neural networks, such as LSTM models. In some embodiments, the models are configured to classify roles of users or various attributes of tasks, and in some cases, these models may be implemented as classification trees, support vector machines, neural networks, naïve Bayes classifiers, boosted decision trees, or the, such models being trained with the corresponding techniques by which the models are defined in the art. In some embodiments, such models may be trained with the training module 40, for instance by processing records in the workflow execution log 33.

In some embodiments, models may be trained multiple times on different subsets of records in the workflow execution log, and some embodiments may compare the performance of various candidate models to select those candidate models that are determined to perform better than the other candidates when processing records in their workflow execution log. In some embodiments, the performance of models may be measured by testing the model in its ability to predict known outcomes of previous workflow instance executions documented in the workflow execution log and measuring an aggregate amount of error or fitness in these predictions, such as a percentage correct classification rate a percentage incorrect classification rate, a root mean square error for scored values, or the like.

A variety of techniques may be used to make the trained models more robust and less likely to be the result of finding a local optimum. Some embodiments may implement the training along with a cross validation procedure by which data withheld during training is applied to the resulting model to evaluate the quality of the resulting model. Further, in some cases, the sample size within the workflow execution log 33 may be extended with bootstrap aggregation techniques by which various subsets of the workflow execution log 33 are sampled and various candidate models are trained on those different sample sets. In some embodiments, models may be trained multiple times with different initial conditions, for instance, by randomly (e.g., pseudo-randomly) setting parameters of the model and retraining the model multiple times with different randomly selected initial conditions on the same training data. Some embodiments may select among the different resulting candidate models on the same training set with different initial conditions according to the above-describe measures of model quality. In some embodiments, this is expected to reduce the likelihood of a model trained in arriving at a local optimum, rather than the global optimum, relative to the training set, being selected.

In some embodiments, models may be trained well in advance of the model being used. For example, training may be performed as part of a batch process, for instance, weekly, monthly, or yearly, while the model may be used relatively frequently. For instance, a given model may be applied to user records or workflow execution state records each time those records are updated or periodically, for instance daily. In some embodiments, models may be replicated on multiple computing devices or in multiple processes on multiple computing devices, and different subsets of data in the status repository or user repository may be sent to those different computing devices or processes for concurrent processing by the models to expedite classification and other inferences. In some cases, these different processes on different computing devices may report back the results the controller 28, and the controller 28 may cause records in the user repository 32 or the status repository 34 to be updated with the resulting inferences or estimations being stored in association with the records to which these inferences are estimations are applied. Thus, in some embodiments the model may get smarter over time. For instance, some embodiments train the model with a certain data set and, then continue to gather training data as people continue to execute certain tasks. The new training data may be fed back into the model to make it smarter over time. This is expected to allow for the model to even adapt as roles in industry change and evolve.

FIG. 2 shows an example of a process 50 that may be performed by the trainer 40 described above, but which is not limited to that implementation, which is not to suggest that any other feature described herein is limited to the arrangement described. Like the other processes described herein, in some embodiments, the process 50 of FIG. 2 may be embodied in program code stored on a tangible, non-transitory, machine readable medium, which as noted below, in some cases may be distributed on multiple computing devices, with different computing devices storing and executing different subsets of the instructions, in some cases at different geographic locations. In some embodiments, some of the instructions may be replicated or omitted, again which is not to suggest that other features described herein are not also amenable to variation.

In some embodiments, the process 50 may begin by obtaining a workflow execution log, as indicated by block 52. In some embodiments, workflow execution logs may be obtained by accessing the workflow execution log 33 described above with reference to FIG. 1, which may contain records that are updated as workflows are completed or otherwise closed by the controller 28 of FIG. 1. Thus, workflow instance records may accumulate over days, weeks, months, or years.

In some embodiments, prior to training the model, the workflow instance records may be grouped according to various criteria, and training sets may be selected from one or more of the groups. For example, some embodiments may group workflow instance records according to the tenant of the project management computer system, according to the team of users that perform the workflow, according to a project to which the workflow applies, or according to a workflow. Some embodiments may train a model for each resulting group, for instance by identifying workflow instance records pertaining to that specific group, and then training a group-specific model based on those identified workflow instance records. Some embodiments may label resulting models with identifiers corresponding to criteria by which the group of training records is selected and, at runtime when using the model, select a model corresponding to an input, such as a model corresponding to a given project based on an input pertaining to that project.

Next, some embodiments may train a machine learning model to infer roles of users in workflows based on the workflow execution log, as indicated by block 54. In some cases, roles may correspond to groups of tasks that tend to be performed by users (e.g., tasks like those performed by a quality assurance engineer), titles of users (e.g., a unit-test specialists), or sequences of users in a workflow (e.g., the role of first, second, third, etc.). Various examples of training are described above. Training techniques generally correspond to the type of model. In some embodiments, the model is a supervised machine learning model in which entries in the workflow instance records served as a labeled training set. Or in some embodiments, the machine learning model may be an unsupervised model, such as a clustering algorithm (e.g., k-means, or DB-SCAN, self-organizing maps, or the like) that infers groups of tasks, users, or workflows, where the resulting groups are not explicitly labeled in the workflow instance records before the model is applied to a workflow or workflow instance.

In some embodiments, the trained model is configured to account for the sequence in which tasks are performed in the workflow instance records. In some embodiments, the trained model is a hidden Markov model. For example, the hidden state in the model may be the role of a user that performs a given task and the observed states may be the tasks that are performed in the particular sequence by users. Some embodiments may infer a transition probability matrix between roles of users or between users that perform tasks based on the sequence with which tasks are performed by users in the workflow instance records. In some embodiments, a hidden Markov model may be trained with the trained with the Baum-Welch algorithm.

In some embodiments, the model is a recurrent neural network, such as an LSTM network, configured to infer roles of users based on the sequence of tasks performed by those users in the workflow instance records. In some embodiments, the corresponding neural network may be a cyclic neural network having nodes that account for earlier and later operations within a workflow instance record. In some embodiments, the neural network may be trained with a gradient descent algorithm, such as a stochastic gradient descent or simulated annealing. For instance, some embodiments may randomly select initial weights for inputs to the various perceptrons in the neural network. In some embodiments may then determine an aggregate measure of fitness or error for the neural network as it exists with the current parameters relative to the training set. Some embodiments may, for instance, determine a root mean square error, a misclassification error rate, or a correct classification rate by determining how often the currently existing model predicts some values of the workflow instance records based on other values of the workflow instance records. Examples include predicting which user operates next in a given workflow or which title of a user performs a task next at a given workflow instance record. Other examples include inferring the sequence with which tasks are performed, which may be indicative of priority of tasks or when tasks will be performed.

In some embodiments, a partial derivative of the aggregate measure of fitness or error with respect to each parameter may be determined or otherwise estimated, and some embodiments may adjust the then current parameter value in a direction that the partial derivative indicates will increase fitness or decrease error in the aggregate relative to the training set. Some embodiments may repeat this measurement and adjustment step iteratively until a termination of condition occurs and is detected. Some embodiments may repeat this process iteratively until a threshold amount of iterations have occurred. Some embodiments may repeat this process iteratively until an amount of change between the amount of fitness or error in the aggregate between successive iterations changes by less than a threshold amount, thereby indicating a local minimum or maximum or possibly global minimum or maximum in error or fitness.

In some cases, models may converge on a local minimum or maximum based on the starting conditions. Accordingly, some embodiments may train multiple candidate models with different starting conditions, such as randomly selected initial weights (e.g. pseudo-randomly selected initial weights), and some embodiments may select a candidate model or result that at the end of training produces the highest aggregate measure of fitness or lowest aggregate measure of error relative to a training set, such as a cross validation training set.

In some embodiments, the model is a decision tree, such as a classification tree, trained with a greedy algorithm that recursively performs binary splits on a parameter space of subsets of the workflow instance training records' fields, such as those subsets that will correspond to known conditions when making inferences later to infer unknown attributes. In some cases, the model may be trained with the classification and regression tree (CART) algorithm. Some embodiments may divide records in the parameter space into groups that produce the lowest aggregate measure of error or the highest aggregate measure of fitness when inferring some attribute that is known from the workflow execution log records. Some embodiments may then select that value in that dimension for a split in the decision tree or classification tree. Some embodiments may then proceed to identify other dimensions in each of the split areas upon which to identify values in those other dimensions to perform subsequent splits, repeating this process until a termination condition is reached, such that as every dimension is evaluated, or an aggregate measure of fitness or error changes by less than a threshold amount. Some embodiments may prune back a certain number of the splits, such as a threshold amount or until a threshold amount of changes in aggregate error or fitness between consecutive splits satisfies (e.g., is greater than or less than, depending on sign) a threshold.

In some embodiments, the resulting parameters of the model may be stored in memory (a term which is used broadly to include persistent storage).

Next, some embodiments may use the model to make inferences about an ongoing workflow. In some cases, this may occur more than an hour, day, week, or month after the model is trained. When using the model, some embodiments may obtain a given instance of a given workflow, as indicated by block 56. In some cases, this given instance of the given workflow may be obtained upon a user completing a task and causing a workflow instance state record to be updated, or in some cases, this may be performed in response to a periodic batch process by which inferences are made.

In some cases, training may include constructing statistical models, for example, determining a measure of central tendency of various parameters, like an average, mean, or mode. These values may be determined for a variety of attributes, like a priority designation applied to tasks by users, amounts of time tasks take, amounts of time between tasks, or amounts of time until a task is performed when a workflow is started. In some embodiments, the statistical models may further include measures of variation of the values in the population by which the measure of central tendency is determined, such as a variance or standard deviation.

Next, some embodiments may infer, with the trained model, a role of a user in the given instance of the given workflow, as indicated by block 58. This may include determining which user will receive which task. In some cases, this inference may be performed by inputting a subset or all of the information in the workflow instance state record into the trained model and outputting, for instance, an identifier of a user to whom the next task or a later unperformed task in the workflow instance is to be assigned. Some embodiments may output a ranking of user identifiers based on inferred likelihood of the respective users being the next user to perform a task in the workflow. In some embodiments, the output is a title of a user on a team inferred to receive a given task. For instance, a given team may have three quality assurance engineers with this title associated with the users in the user repository 32 described above. In some cases, certain tasks in workflows may not be designated as pertaining to those bearing particular titles, but based on the historical records in the workflow execution log, some embodiments may train a model by which this title is associated with certain tasks based on a historical pattern of users with that title performing those tasks. In some embodiments, each of a plurality of tasks remaining to be performed in the given instance of the given workflow may be assigned to users, or a ranking of users may be presented, or a ranking of titles of users may be presented based on the inference of block 58. Or some embodiments may select and present a top ranked user or title.

In some embodiments, other inferences may be made. Some embodiments may infer a duration of time until a given task will be performed, for instance, based on the above-describe statistical models, choosing, for instance, to report the measure of central tendency with respect to some duration of time related to a task. Some embodiments may access a mean duration of time until previous instances of that task were performed historically and report that duration of time as a predicted time until the task will be performed.

In other examples, some embodiments may infer a priority of tasks in the given instance of the given workflow based on the historical records. For instance, in some cases, users may historically manually designate tasks according to priority, and some embodiments may learn to apply those designations to other similar tasks, such as other tasks performed by users with the same job title, users performing tasks having certain keywords in the task description, or users performing tasks pertaining to certain projects or bodies of code. In some embodiments, the historical workflow instance records may not include manual labeling of task priority, and some embodiments may infer task priority based on amounts of time between workflows beginning historically and when the tasks were performed. Or some embodiments may infer priority based on the sequence with which tasks were performed historically that did not require in the workflow a particular sequence explicitly.

Some embodiments may also infer durations of time until task will be performed based on queues of tasks assigned to users, for instance, pertaining to multiple projects. Some embodiments may execute a bin packing algorithm (like a first fit algorithm), in some cases performing a greedy optimization according to priority assigned or inferred for tasks and estimate when a given task in the given workflow will be performed based on a result of the bin packing algorithm.

Some embodiments may cause the given instance of the given workflow to be presented to a user, as indicated by block 60. In some cases, this may include adding a task to a given user's workload queue and, in a response to a request for a user interface from a client computing device operated by that user, sending instructions to the client computing device to display, for instance, in a web browser, a list of tasks assigned to that user from the queue. In some cases, these queues may be constructed with the above-described bin packing algorithm. Thus, in virtue of the user having a role that was inferred to apply to the given workflow, such as a given task in the given workflow in the given instance, that user may be presented with at least part of the given workflow in a user interface, for instance, indicating that the user is to perform the task and providing a link to resources by which the task is performed or inputs by which the user indicates that the task has been completed or supplies comments related to the task. In some cases, these inputs may be received by the above-describe project management computer system 12 and the controller 28 may apply updates may to the corresponding workflow instance state record in the status repository 34.

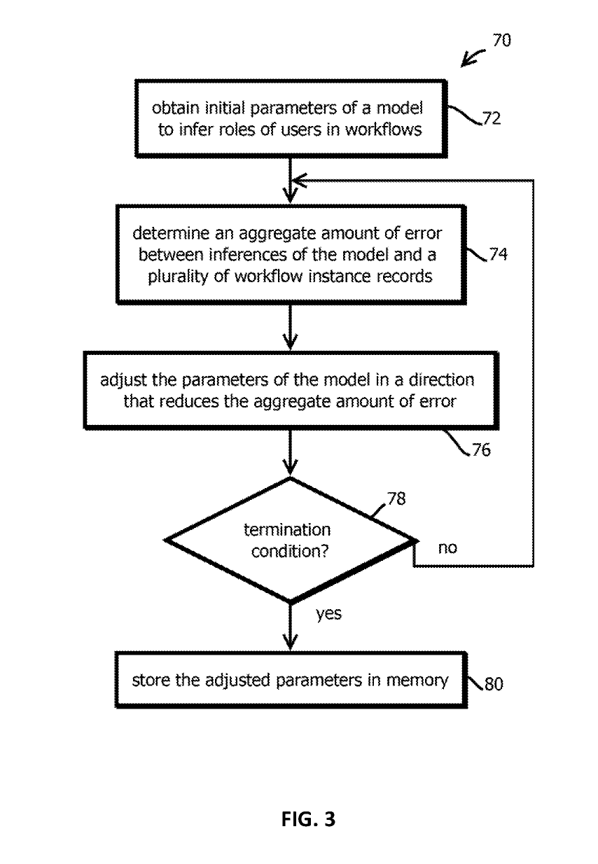

FIG. 3 shows an example of a process 70 by which a model may be trained. In some embodiments, the process 70 includes obtaining initial parameters of a model to infer roles of users in workflows, as indicated by block 72. Next, some embodiments may determine an aggregate amount of error between inferences of the model in a plurality of workflow instance records, as indicated by block 74. Or as noted above, embodiments may determine an aggregate amount of fitness (e.g., a single value indicative of the collection of fitness or error values). Aggregate amounts may include evaluating candidates for a next date in a transition probability matrix. Determining an aggregate amount of error may include evaluating candidates for splits in a dimension in a decision (or classification) tree training algorithm. Or determining an aggregate amount of error may include evaluating various candidate dimensions upon which to make such binary splits.

Some embodiments may then adjust parameters of the model in a direction that reduces the aggregate amount of error, as indicated by block 76. In some cases, this may include adjusting a weight in a neural network based on a partial derivative like those described above, for instance in a direction that the partial derivative indicates will reduce the aggregate amount of error or increase the aggregate amount of fitness. In some cases, adjusting the parameter includes populating a transition probability matrix of a hidden Markov model. In some cases, adjusting the parameter includes selecting a next dimension upon which to split in a classification tree or a decision tree. In some cases, adjusting the parameter (which may be a null value or other value not yet defined) includes selecting a value on that dimension upon which to perform a binary split.

Next, some embodiments may determine whether a termination condition has occurred, as indicated by block 78. Various examples of termination conditions are described above. Upon determining that this condition has not occurred, embodiments may return to block 74 and continue to evaluate aggregate amounts of error (or fitness) and adjust parameters. Upon determining that a termination condition has occurred, some embodiments may store the adjusted parameters in memory, as indicated by block 80.

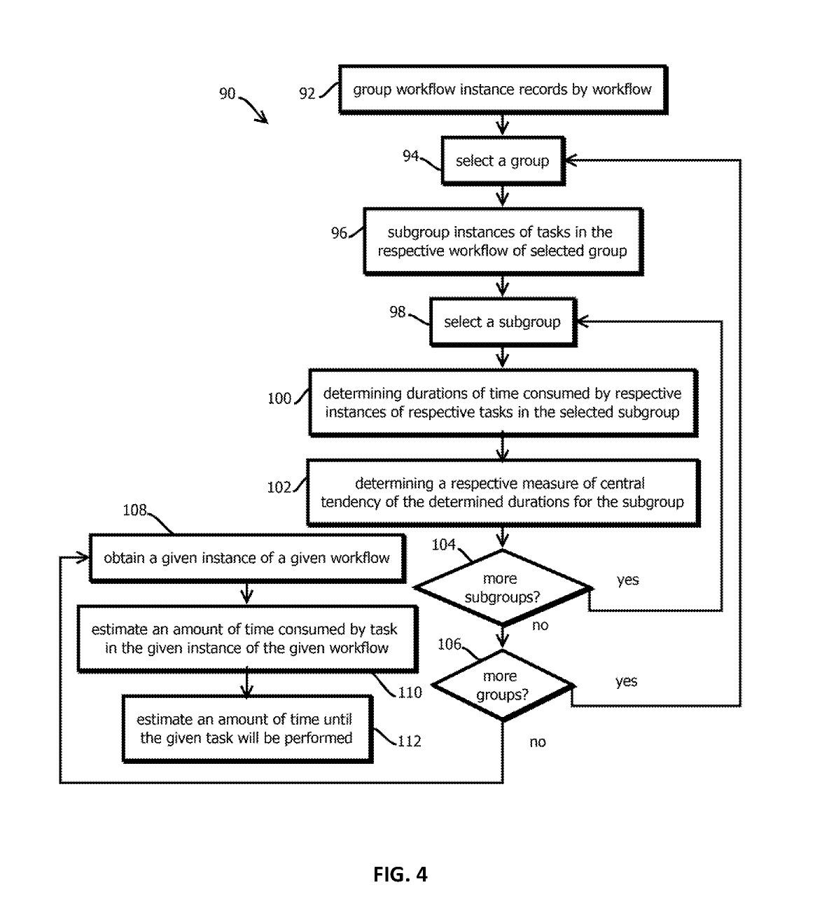

FIG. 4 shows an example of a process 90 configured to construct and use various types of statistical models to make inferences (e.g., predictions or estimations) related to workflow instances. In some embodiments, the process 90 begins with grouping workflow instance records by workflow, as indicated by block 92. Next, some embodiments may select a group among the groups produced by block 92, as indicated in block 94. Next, some embodiments may subgroup instances of tasks in the respective workflow of the selected group, as indicated by block 96, and select a subgroup, as indicated by block 98. Next, some embodiments may determine durations of time consumed by respective instances of respective tasks in the selected subgroup, as indicated by block 100. In some cases, this may include accessing timestamps associated with various task records, such as start and stop times, or start time between sequential tasks performed by the same user. In some cases, this may include subtracting these values. Next, some embodiments may determine a respective measure of central tendency of the determined durations for the subgroup, as indicated by block 102. In some cases, this may include calculating a mean, median, or mode value. Further, some embodiments may calculate various measures of variation, such as variance or standard deviation of these distributions. In some cases, the measure of central tendency may be obtained by, for instance randomly, sampling from a population and determining the measure of central tendency on the sample group.

Next, some embodiments may determine whether there are more subgroups, as indicated by block 104, corresponding to different tasks in the selected workflow. Upon determining that there are more subgroups, some embodiments may return to block 98. Upon determining that there are no more subgroups, some embodiments may determine whether there are more groups, as indicated by block 106. Upon determining that there are more groups, some embodiments may return to block 94 and select a different group to process, corresponding to a different workflow. Upon determining that there are no more groups, some embodiments may proceed to use a resulting statistical model. In some cases, different groups or subgroups may be processed concurrently, for instance with a MapReduce framework or library, like Hadoop™. In some cases, subgroups may be assigned to different worker node processes on different computers, and those processes may report back measures of central tendency.

In some cases, the statistical models may be stored in memory in association with identifiers of groups and subgroups, such as workflow and task identifiers.

Next, some embodiments obtain a given instance of a given workflow, as indicated by block 108. The given instance of the given workflow may be a partially completed workflow, which may be obtained in response to a user updating a record corresponding to the given instance of the given workflow via a user interface.

Next, some embodiments may estimate an amount of time consumed by a task in the given instance of the given workflow, as indicated by block 110. In some cases, this may include estimating an amount of time consumed by each task in the given instance of the given workflow. In some cases, this may include estimating an amount of time until the task is started, until the task is completed, or both. In some cases, estimating may include accounting for other tasks assigned to users in a role to which the given task was inferred to apply with the process of FIGS. 2 and 3. As noted above, some embodiments may execute a bin packing algorithm that performs a greedy optimization according to priority or age of tasks or workflows to infer the sequence with which tasks in queues will be performed by users in the future to estimate an amount of time until the task in the given instance of the given workflow is begun or completed. Such algorithms may account for both priority and sequences of tasks in workflows, e.g., which tasks block which other tasks.

Some embodiments predict team or company velocity on a given project or set of projects based on predicted effort (or amounts of time consumed per developer) per task in those projects. Some embodiments may use these predictions to manage workflow buffers for developers, e.g., differences between developer capacity (e.g., in hours per week) and predicted amounts of time used by developers on assigned tasks, to leave room to handle interruptions (e.g., fixing unexpected bugs, answering questions, or interfacing with customers) not explicitly within the scope of assigned tasks. Some embodiments may assign tasks with predicted degrees of efficiency, e.g. 90% capacity for the first iteration, 70%, 60%, 50% (with the difference from 100% being a buffer) for following to allow for interrupt work. To that end, some embodiments may calculate how much interrupt has occurred in the past to predict future buffers.

Next, some embodiments may estimate an amount of time until the given task will be performed, as indicated by block 112. Some embodiments may output these estimates, for instance, by sending instructions to a user computing device to display a user interface indicating these estimates. In some cases, the user interfaces may further include values presented on a display screen indicating an estimated or otherwise inferred priority of the tasks in the given instance of the given workflow obtained with the techniques described above.

Thus, some embodiments may infer attributes of tasks or roles of users in workflows in project management computer systems without users having to manually enter these values and, in some cases, in a manner that is relatively robust to future changes in use cases of the workflow management computer system, thereby avoiding some of the challenges with traditional techniques for automating application of such values.

FIG. 5 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times, e.g., a copy may be created by writing program code to a first-in-first-out buffer in a network interface, where some of the instructions are pushed out of the buffer before other portions of the instructions are written to the buffer, with all of the instructions residing in memory on the buffer, just not all at the same time.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

In this patent, certain U.S. patents, U.S. patent applications, or other materials (e.g., articles) have been incorporated by reference. The text of such U.S. patents, U.S. patent applications, and other materials is, however, only incorporated by reference to the extent that no conflict exists between such material and the statements and drawings set forth herein. In the event of such conflict, the text of the present document governs.

The present techniques will be better understood with reference to the following enumerated embodiments:

1. A method, comprising: obtaining, with one or more processors, a workflow execution log, wherein: the workflow execution log comprises a plurality of workflow instance records, each workflow instance record documents a respective instance of a respective workflow being executed, the workflow instance records describe a plurality of different workflows, each workflow includes a plurality of tasks, each workflow has a plurality of different workflow instance records in the workflow execution log, and each workflow instance record indicates which user performed each of the plurality of tasks in the respective workflow, training, with one or more processors, a first supervised machine learning model to infer roles of users in the workflows based on the workflow execution log, wherein training the first model to infer roles of users in the workflows comprises: obtaining initial parameters of the first model to infer roles of users in the workflows; repeatedly, until a termination condition occurs, determining an aggregate amount of error or fitness between inferences of the first model and a plurality of the workflow instance records, and adjusting the parameters of the first model in a direction that reduces the aggregate amount of error or increases the aggregate amount of fitness; and storing the adjusted parameters in memory; after training the first supervised machine learning model, obtaining, with one or more processors, a given instance of a given workflow; inferring, with one or more processors implementing the first supervised machine learning model, at least one role of at least one user in the given instance of the given workflow; and causing, with one or more processors, based on inferring the at least one role of the at least one user, at least part of the given instance of the given workflow to be presented to the at least one user in a user interface.
2. The method of embodiment 1, wherein: obtaining the workflow execution log comprises hosting a multi-tenant workflow management system for more than 10,000 users to track more than 1,000 software development or maintenance projects and logging user progress through workflows over more than one month to obtain more than 20,000 workflow instance records; each workflow instance record includes values indicating durations of time between the tasks in the respective workflow instance; the workflow management system stores a plurality of team records, each team recording identifying groups of users on a respective team among a plurality of teams; the workflow management system stores a plurality of workflow templates created by members of the teams; at least some of the workflows pertain to addressing software issue reports and include tasks of changing source code and checking changes in source code by another user; inferring at least one role comprises inferring that a plurality of users on a team associated with given instance of the given workflow having the role of checking changes in source code by another user and assigning a code-checking task in the given instance of the given workflow to at least one of the plurality of users on a team; and the operations comprise hosting a multi-tenant project management system that interfaces with a source code version control system to track status of the workflows in source code development or maintenance projects, wherein causing at least part of the given instance of the given workflow to be presented to the at least one user in the user interface comprises predictively adding tasks to the given user's queue in the multi-tenant project management system and sending instructions to a client computing device associated with a user account of the given user to display at least part of the queue.
3. The method of any one of embodiments 1-2, comprising: constructing a second model to predict a duration of time taken by tasks in at least some of the workflows based on the workflow execution log, wherein constructing the second model comprises: grouping workflow instance records by workflow; for each group, subgrouping instances of tasks in the respective workflow; for each subgroup, determining durations of time consumed by respective instances of respective tasks and determining a respective measure of central tendency of the determined durations; and estimating a time consumed by a given task in the obtained given instance of the given workflow based on a measure of central tendency of a corresponding task in a corresponding workflow of the second model.
4. The method of embodiment 3, comprising: estimating a duration of time until the given task will be performed or completed by obtaining task queues of a plurality of users and inputting the task queues into a bin packing algorithm that performs a greedy optimization of task sequencing.
5. The method of any one of embodiments 1-4, comprising: constructing a third model to infer priorities of tasks in instances of the workflows, wherein constructing the second model comprises determining a measure of central tendency of priority designations applied to instances of tasks in the workflow instance records.
6. The method of any one of embodiments 1-5, comprising: constructing a third model to infer priorities of tasks in instances of the workflows, wherein constructing the third model comprises determining a measure of central tendency of durations of time before instances of tasks in the workflow instance records are performed and calculating respective priority scores based on the measure of central tendency; wherein causing at least part of the given instance of a given workflow to be presented to the at least one user in a user interface comprises selecting a task in the given instance of the given workflow based on a priority score associated with the selected task.
7. The method of any one of embodiments 1-6, wherein training the first supervised machine learning model to infer roles of users in the workflows comprises: constructing a matrix of transition probabilities for the given workflow between users on a team or titles of users on a team based on workflow instance records.
8. The method of any one of embodiments 1-7, wherein training the first supervised machine learning model to infer roles of users in the workflows comprises: training a recurrent neural network to infer a next user or next title of a user based on workflow instance records.
9. The method of embodiment 8, wherein training the recurrent neural network comprises iteratively adjusting weights of the recurrent neural network based on a partial derivative of the measure of aggregate error or aggregate fitness of the first model relative to the workflow execution log.
10. The method of any one of embodiments 1-8, wherein: training the first supervised machine learning model to infer roles of users in the workflows comprises training means for inferring roles of users in workflows.
11. The method of any one of embodiments 1-10, comprising: constructing a fourth model to infer responsibility of users for bodies of source code based on the workflow execution log, wherein constructing the fourth model comprises: identifying bodies of source code; scoring, for at least some bodies of source code, a plurality of users based on amounts of changes to the respective body of source code by the respective user; and for each of the at least some bodies of source code, ranking a plurality users based on the scores.
12. The method of embodiment 11, wherein inferring at least one role of at least one user in the given instance of the given workflow comprises: identifying a given body of source code to which the given instance of the given workflow pertains; and determining that the at least one user is ranked above a threshold in a ranking corresponding to the given body of source code.
13. The method of any one of embodiments 1-12, wherein training the first supervised machine learning model to infer roles of users in the workflows comprises: repeated, until a termination condition occurs: selecting a dimension in an attribute space of input to the first supervised machine learning model; scoring a plurality of candidate binary splits of the attribute space in the selected dimension according to aggregate error or fitness of the first supervised machine learning model produced by the candidate binary splits; and selecting one of the candidate binary splits as a parameter of the first supervised machine learning model based on the scoring.
14. The method of any one of embodiments 1-14, wherein the operations comprise: obtaining a plurality of instances of the given workflow or other workflows; and inferring roles of users in the plurality of instances with the first supervised machine learning model.
15. A method, comprising: obtaining a first machine learning model trained to infer roles of users in workflows, the first machine learning model being trained on a workflow execution log; obtaining a second model configured to infer priorities of tasks in the workflows, the second model being constructed based on express or implied priorities of tasks indicated by the workflow execution log; obtaining a given instance of a given workflow; inferring, with the first machine learning model, at least one role of at least one user in the given instance of the given workflow; inferring, with the second model, a priority of a given task in the given workflow; and causing, based on inferring the at least one role of the at least one user and the priority, at least part of the given instance of the given workflow to be presented to the at least one user in a user interface, the at least part of the given instance of the given workflow indicating the inferred priority of the given task.
16. A tangible, non-transitory, machine-readable medium storing instructions that when executed by a data processing apparatus cause the data processing apparatus to perform operations comprising: the operations of any one of embodiments 1-15.
17. A system, comprising: one or more processors; and memory storing instructions that when executed by the processors cause the processors to effectuate operations comprising: the operations of any one of embodiments 1-15.

What is claimed is:

1. A method, comprising:
obtaining, with one or more processors, a workflow execution log, wherein:
the workflow execution log comprises a plurality of workflow instance records,
each workflow instance record documents a respective instance of a respective workflow being executed,
the workflow instance records describe a plurality of different workflows,
each workflow includes a plurality of tasks,
each workflow has a plurality of different workflow instance records in the workflow execution log, and
each workflow instance record indicates which user performed each of the plurality of tasks in the respective workflow,
training, with one or more processors, a first supervised machine learning model to infer roles of users in the workflows based on the workflow execution log, wherein training the first model to infer roles of users in the workflows comprises:
obtaining initial parameters of the first model to infer roles of users in the workflows;
repeatedly, until a termination condition occurs, determining an aggregate amount of error or fitness between inferences of the first model and a plurality of the workflow instance records, and adjusting the parameters of the first model in a direction that reduces the aggregate amount of error or increases the aggregate amount of fitness; and
storing the adjusted parameters in memory;
after training the first supervised machine learning model, obtaining, with one or more processors, a given instance of a given workflow;
inferring, with one or more processors implementing the first supervised machine learning model, at least one role of at least one user in the given instance of the given workflow; and
causing, with one or more processors, based on inferring the at least one role of the at least one user, at least part of the given instance of the given workflow to be presented to the at least one user in a user interface.

2. The method of claim 1, wherein:
obtaining the workflow execution log comprises hosting a multi-tenant workflow management system for more than 10,000 users to track more than 1,000 software development or maintenance projects and logging user progress through workflows over more than one month to obtain more than 20,000 workflow instance records;
each workflow instance record includes values indicating durations of time between the tasks in the respective workflow instance;
the workflow management system stores a plurality of team records, each team recording identifying groups of users on a respective team among a plurality of teams;
the workflow management system stores a plurality of workflow templates created by members of the teams;
at least some of the workflows pertain to addressing software issue reports and include tasks of changing source code and checking changes in source code by another user;
inferring at least one role comprises inferring that a plurality of users on a team associated with given instance of the given workflow having the role of checking changes in source code by another user and assigning a code-checking task in the given instance of the given workflow to at least one of the plurality of users on a team; and
the operations comprise hosting a multi-tenant project management system that interfaces with a source code version control system to track status of the workflows in source code development or maintenance projects, wherein causing at least part of the given instance of the given workflow to be presented to the at least one user in the user interface comprises predictively adding tasks to the given user's queue in the multi-tenant project management system and sending instructions to a client computing device associated with a user account of the given user to display at least part of the queue.

3. The method of claim 1, comprising:
constructing a second model to predict a duration of time taken by tasks in at least some of the workflows based on the workflow execution log, wherein constructing the second model comprises:
grouping workflow instance records by workflow;
for each group, subgrouping instances of tasks in the respective workflow;
for each subgroup, determining durations of time consumed by respective instances of respective tasks and determining a respective measure of central tendency of the determined durations; and
estimating a time consumed by a given task in the obtained given instance of the given workflow based on a measure of central tendency of a corresponding task in a corresponding workflow of the second model.

4. The method of claim 3, comprising:
estimating a duration of time until the given task will be performed or completed by obtaining task queues of a plurality of users and inputting the task queues into a bin packing algorithm that performs a greedy optimization of task sequencing.

5. The method of claim 1, comprising:
constructing a third model to infer priorities of tasks in instances of the workflows, wherein constructing the second model comprises determining a measure of central tendency of priority designations applied to instances of tasks in the workflow instance records.

6. The method of claim 1, comprising:
constructing a third model to infer priorities of tasks in instances of the workflows, wherein constructing the third model comprises determining a measure of central tendency of durations of time before instances of tasks in the workflow instance records are performed and calculating respective priority scores based on the measure of central tendency;
wherein causing at least part of the given instance of a given workflow to be presented to the at least one user in a user interface comprises selecting a task in the given instance of the given workflow based on a priority score associated with the selected task.

7. The method of claim 1, wherein training the first supervised machine learning model to infer roles of users in the workflows comprises:
constructing a matrix of transition probabilities for the given workflow between users on a team or titles of users on a team based on workflow instance records.

8. The method of claim 1, wherein training the first supervised machine learning model to infer roles of users in the workflows comprises:
training a recurrent neural network to infer a next user or next title of a user based on workflow instance records.

9. The method of claim 8, wherein training the recurrent neural network comprises iteratively adjusting weights of the recurrent neural network based on a partial derivative of the measure of aggregate error or aggregate fitness of the first model relative to the workflow execution log.

10. The method of claim 1, wherein:
training the first supervised machine learning model to infer roles of users in the workflows comprises training means for inferring roles of users in workflows.

11. The method of claim 1, comprising:
constructing a fourth model to infer responsibility of users for bodies of source code based on the workflow execution log, wherein constructing the fourth model comprises:
identifying bodies of source code;
scoring, for at least some bodies of source code, a plurality of users based on amounts of changes to the respective body of source code by the respective user; and
for each of the at least some bodies of source code, ranking a plurality users based on the scores.

12. The method of claim 11, wherein inferring at least one role of at least one user in the given instance of the given workflow comprises:
identifying a given body of source code to which the given instance of the given workflow pertains; and
determining that the at least one user is ranked above a threshold in a ranking corresponding to the given body of source code.

13. The method of claim 1, wherein training the first supervised machine learning model to infer roles of users in the workflows comprises:
repeated, until a termination condition occurs:
selecting a dimension in an attribute space of input to the first supervised machine learning model;
scoring a plurality of candidate binary splits of the attribute space in the selected dimension according to aggregate error or fitness of the first supervised machine learning model produced by the candidate binary splits; and
selecting one of the candidate binary splits as a parameter of the first supervised machine learning model based on the scoring.

14. The method of claim 1, wherein the operations comprise:
obtaining a plurality of instances of the given workflow or other workflows; and
inferring roles of users in the plurality of instances with the first supervised machine learning model.

15. A tangible, non-transitory, machine-readable medium storing instructions that when executed by one or more computing devices effectuate operations comprising:
obtaining, with one or more processors, a workflow execution log, wherein:
the workflow execution log comprises a plurality of workflow instance records,
each workflow instance record documents a respective instance of a respective workflow being executed,
the workflow instance records describe a plurality of different workflows,
each workflow includes a plurality of tasks,
each workflow has a plurality of different workflow instance records in the workflow execution log, and
each workflow instance record indicates which user performed each of the plurality of tasks in the respective workflow,
obtaining, with one or more processors, a trained first supervised machine learning model to infer roles of users in the workflows based on the workflow execution log, wherein training the first model to infer roles of users in the workflows comprises:
obtaining initial parameters of the first model to infer roles of users in the workflows;
repeatedly, until a termination condition occurs, determining an aggregate amount of error or fitness between inferences of the first model and a plurality of the workflow instance records, and adjusting the parameters of the first model in a direction that reduces the aggregate amount of error or increases the aggregate amount of fitness; and
storing the adjusted parameters in memory;
after obtaining the first supervised machine learning model, obtaining, with one or more processors, a given instance of a given workflow;
inferring, with one or more processors implementing the first supervised machine learning model, at least one role of at least one user in the given instance of the given workflow; and
causing, with one or more processors, based on inferring the at least one role of the at least one user, at least part of the given instance of the given workflow to be presented to the at least one user in a user interface.

16. The medium of claim 15, the operations comprising:
constructing a second model to predict a duration of time taken by tasks in at least some of the workflows based on the workflow execution log, wherein constructing the second model comprises:
grouping workflow instance records by workflow;
for each group, subgrouping instances of tasks in the respective workflow;
for each subgroup, determining durations of time consumed by respective instances of respective tasks and determining a respective measure of central tendency of the determined durations; and
estimating a time consumed by a given task in the obtained given instance of the given workflow based on a measure of central tendency of a corresponding task in a corresponding workflow of the second model.

17. The medium of claim 15, the operations comprising:
constructing a third model to infer priorities of tasks in instances of the workflows, wherein constructing the third model comprises determining a measure of central tendency of durations of time before instances of tasks in the workflow instance records are performed and calculating respective priority scores based on the measure of central tendency;
wherein causing at least part of the given instance of a given workflow to be presented to the at least one user in a user interface comprises selecting a task in the given instance of the given workflow based on a priority score associated with the selected task.

18. The medium of claim 15, wherein training the first supervised machine learning model to infer roles of users in the workflows comprises:
constructing a matrix of transition probabilities for the given workflow between users on a team or titles of users on a team based on workflow instance records;
training a recurrent neural network to infer a next user or next title of a user based on workflow instance records, wherein training the recurrent neural network comprises iteratively adjusting weights of the recurrent neural network based on a partial derivative of the measure of aggregate error or aggregate fitness of the first model relative to the workflow execution log; or
repeated, until a termination condition occurs:
selecting a dimension in an attribute space of input to the first supervised machine learning model;
scoring a plurality of candidate binary splits of the attribute space in the selected dimension according to aggregate error or fitness of the first supervised machine learning model produced by the candidate binary splits; and
selecting one of the candidate binary splits as a parameter of the first supervised machine learning model based on the scoring.

19. The medium of claim 15, the operations comprising:
hosting a multi-tenant project management system that interfaces with a source code version control system to track status of the workflows in source code development or maintenance projects, wherein causing at least part of the given instance of the given workflow to be presented to the at least one user in the user interface comprises predictively adding tasks to the given user's queue in the multi-tenant project management system and sending instructions to a client computing device associated with a user account of the given user to display at least part of the queue.

20. A system, comprising:
one or more processors; and
memory storing instructions that when executed by at least some of the processors effectuate operations comprising:
obtaining a first machine learning model trained to infer roles of users in workflows, the first machine learning model being trained on a workflow execution log;
obtaining a second model configured to infer priorities of tasks in the workflows, the second model being constructed based on express or implied priorities of tasks indicated by the workflow execution log;
obtaining a given instance of a given workflow;
inferring, with the first machine learning model, at least one role of at least one user in the given instance of the given workflow;
inferring, with the second model, a priority of a given task in the given workflow; and
causing, based on inferring the at least one role of the at least one user and the priority, at least part of the given instance of the given workflow to be presented to the at least one user in a user interface, the at least part of the given instance of the given workflow indicating the inferred priority of the given task.
